(19) United States
(12) Patent Application Publication
(10) Pub. No.: US 2007/0124248 A1
(43) Pub. Date: May 31, 2007

(54) Media property monetization apparatus and method

(76) Inventor: Russell Ray Stoker, Grapevine, TX (US)

Correspondence Address: J. CHARLES DOUGHERTY, 200 WEST CAPITOL AVE, SUITE 2300, LITTLE ROCK, AR, 72201, US

(21) Appl. No.: 11/290,250

(22) Filed: Nov. 30, 2005

(51) Int. Cl. G06Q 99/00

(52) U.S. Cl. 705/51

(57) ABSTRACT

A monetization method and system for time-shifted media properties such as “podcasts” and the like is shown and described. The system uses a content server to coordinate the distribution of media properties as content premiums for the purpose of goods or services from applicable retailers. The retailers may provide immediate transfer of the content premium or premiums to a consumer storage device, or may provide keys or other means of accessing such content premiums at a remote location.

### BACKGROUND OF THE INVENTION

The present invention relates to advertising and marketing methods and systems, and in particular a monetization method and system for time-shifted media properties such as “podcasts” and the like.

The objective behind all advertising and marketing models is to influence or alter consumption or purchase behavior. Advertising may be generally defined as the presentation of marketing messages for a product or service through any media form or combination of media forms. A basic premise of advertising is that these messages can alter consumption or purchase behavior. These messages focus on describing either the attributes of the product or service, or the attributes that the consumer will acquire or with which the consumer will be associated by the purchase of the product or service.

In order for advertising to be effective, the advertiser must (1) determine how to position the message within the attention of the consumer; (2) identify the optimum combination of product attributes or associations that will alter purchase behavior; and (3) craft a message using the attributes or associations that will effectively alter the purchase or consumption behavior. The difficulties of the advertiser are particularly acute where the attributes between any two products or services are not highly differentiated. In such cases, the message—what may broadly be referred to in this context as the “brand”—is constructed almost entirely of associations that a consumer acquires by purchasing the product.

Brands pose a number of challenges for advertisers. First, consumers have today become less brand-susceptible. This has occurred for two reasons. First, as consumers have become more sophisticated regarding the origin and manufacturer of products and services, they are cognizant of the value-added attributes and their corresponding costs over the base product. Second, consumers are now more consciously aware of marketing messages, their strategy, composition, and intended effect. This awareness diminishes the effectiveness of advertising.

It is well known that brands require mass adoption to become powerful. Brands achieve most of their power—and value—as substitutes for either knowledge or membership. Where brands substitute for knowledge, the consumer acquires comfort, or a sense of guarantee, by a brand purchase. Where brands substitute for membership, consumers are able to recognize either themselves or their peers as belonging to a particular social strata or special-interest group. In both cases, the substitution conferred with a brand must be widely understood and acknowledged in order to have value. Given these two problems, and the expense involved in attempting to overcome them, it may be easily seen how brands are losing their power to alter consumption behavior.

For purposes of illustration, a particular example of the problem of brand erosion will be used in the subsequent discussion. Consider the situation whereby an advertiser “underwrites” a television program by purchasing broadcast time sold by the television station or broadcaster. Following the traditional model, advertising is inserted interstitially into the program, that is, the advertising appears during short segments before, during, or after a program. The program is said to be “sponsored” by the advertiser through this arrangement.

A first disadvantage of this interstitial advertising model is that the advertising time purchased is associated with a specific calendar date and time. The advertising is not integrally associated with the media property. If, for example, the program is later released on digital video disk (DVD) for purchase by end consumers, the advertising will not be associated with the program unless the advertiser makes an additional purchase of advertising time.

Another disadvantage is that the broadcaster who is selling the advertising time is a licensee of the media property, and generally not the content producer. The broadcaster is thus in some sense an intermediary to the advertiser and the owner of the media property. Therefore, the advertiser must negotiate with different parties to “sponsor” the media property in different formats and environments, leading to the problem of an advertising purchase being related to a particular date and time as described above.

Another disadvantage of this approach is that the broadcast company owns the broadcast rights to a program, and thus controls the time when it is broadcast to a particular audience. The sponsor thus lacks the ability to optimize the time that a program is broadcast in order to best suit its advertising needs. The sponsor cannot control this or any other aspect of the program, and thus any deficiencies in the program or its broadcasting, which may reflect negatively on the sponsor, are outside of the sponsors' control. The sponsor may only influence these activities by failing to renew or expand its advertising purchase.

Yet another disadvantage of this approach is that the sponsor is responsible for creating the advertisement that will appear interstitially during the program. Few sponsors are capable of creating such content themselves, lacking both the creative talent and resources necessary for such production. The sponsors must then rely upon third-party advertising firms (or in some cases upon the broadcaster itself) to produce its advertisements.

It may be seen that there are a number of disadvantages that relate particularly to the purchase of advertising in interstitial blocks of time associated with a particular program. For example, a broadcaster may decide to move a successful program to a new time slot in order to raise the cost to the advertiser of maintaining its sponsorship. In addition, the advertisements developed for such programs must generally conform to the tight timeframe constraints on the program to feature the advertising, which generally falls on multiples of a half-hour or hour-length program. This limitation is the result of audience expectation, and the difficulty of communicating program start times to the audience if these rigid limits were not imposed. Related to this limitation is the limitation that the programs generally appear in weekly installments. Another limitation is that since there are only a limited number of “prime time” slots, the programs broadcast at these times must be those that are felt to have broad appeal, that is, those that can attract multiple audience demographics with disparate advertising targets. This broad reach limits the ability of a sponsor to focus its marketing efforts at a core group of potential buyers.

Another more general limitation of this approach to advertising is that there need be no prior relationship between the sponsor of the program and the viewer. The viewer may have no interest in the sponsor whatsoever, and viewing the program does not create any relationship between the viewer and sponsor unless the viewer affirmatively acts to create such a relationship. The only relationship established is that between the viewer and the broadcaster, since the viewer must have chosen to watch the particular program that is being sponsored.

The prevalence today of audio and video recording devices further compounds certain of these problems. Since viewers can record a particular program and watch it at any time desired, the broadcaster essentially competes against itself; the viewer can skip a program currently being broadcast and can instead watch one that was previously recorded from the same broadcaster. This effect compounds the difficulties associated with the high-value program, since it can effectively be watched by more viewers. Conversely, this effect accelerates the devaluation of sponsorship for less popular programs, since the viewer may now skip a program it might watch as the best available in a particular time slot in favor of a more desirable program recorded earlier.

In particular, the use of audio and video recording devices creates a difficulty for the standard advertising model because viewers can now skip advertising altogether. Video cassette recorders allow viewers to “fast forward” past advertisements in order to view a desired program without being exposed to the interstitial advertising messages. Digital video recording devices (DVRs), such as the TiVo brand recording device, as well as similar devices now commonly leased to digital satellite and cable television subscribers, allow viewers to skip advertisements in a highly automated fashion. Many DVR controllers allow the viewer to skip ahead in a program by thirty-second increments with the mere touch of a button; thirty seconds is precisely the amount of time allotted to most television advertisements. Other systems have “smart” technology that automatically skip advertisements during viewing.

Another new technology available to consumers today is in the form of digital audio file players. The mostpopular of these devices is the iPod media player from Apple Computer of Cupertino, Calif. Such devices are analogous to DVRs in that they store programs, in this case audio programs such as songs or “podcasts,” for later review. While the DVR, iPod, and like devices have proven to be incredibly popular, no new monetization model has appeared to take advantage of the unique opportunities these devices create for leveraging advertising expenditures. Any attempt to insert advertising into podcasts interstitially will suffer from the same drawbacks as described above with respect to programs recorded by DVR—the consumer may easily skip the advertisements to move along to the desired content given the capabilities of the device.

Although no satisfying answer has been forthcoming, the difficulties associated with the monetization of podcasts and similar programs has been widely recognized. Audible.com, a downloadable audiobook company, has developed a service called “Wordcast” that allows podcasters to dynamically insert ads, measure number of listeners, and charge subscription fees. This traditional advertising approach suffers from many of the disadvantages described above, particularly the problem that the listener can easily skip the advertisement. Also, there is no way to know how many times the advertisement is actually heard, only the number of times the program containing the advertisement is downloaded. Odeo, a start-up company located in San Francisco, Calif. has also developed an advertising model that relies upon the embedding of advertising in podcasts. One podcasting pioneers, Avi Partovi of GarageBand.com, has advocated shortening the embedded commercials in podcasts such that it would be too much trouble to skip them. This approach would limit the impact of the advertisement, and limit the type of message that may be conveyed by the advertiser.

It may be seen then that traditional methods of advertising using program sponsorship are of diminishing value in a modem technological environment, particularly with respect to time-shifted media, and a more effective method of advertising and sponsorship is desired. Previous attempts to modify traditional advertising approaches to fit the podcasting model have been unsatisfying and appear unlikely to be effective.

### SUMMARY OF THE INVENTION

The present invention is directed to an apparatus and method for advertising with respect to time-shifted media properties, which maximizes the value of the advertisement to the sponsor. Rather than being limited by the prevalence of time-shifted content storage players or appliances, such as DVRs and iPods, the present invention is enabled by such technologies. According to the present invention, the desired media content is provided to the consumer on the applicable content storage player in response to the customer having satisfied certain terms and conditions.

For purposes herein, this content to be transferred, in whatever form it may take in various embodiments, is referred to as a “content premium.” Generally speaking, the content premium is to be provided to a customer as an incentive for the purchase of a corresponding product or service. The content premium may be any audio, video, text, interactive game, music, text-to-speech rendition, or other media property, whether for entertainment purposes, news, or otherwise, whose acquisition and transfer to a consumer for review by the customer is conditional upon (1) the satisfaction of the purchase of a good or service; (2) the exchange of data from the customer; (3) the participation of the customer in a designated activity; or (4) other activity of the customer by which a relationship is established with the content server and from which the content server derives value. Examples of content premiums may include, but are not limited to, Podcasts, Vlogs, website content, blog content, and media-shifted television programs, movies, or radio programs. A content premium may also include a token that represents a physical artifact that may be, for example, shipped to a customer in response to receipt or conversion of the content premium. For example, the content premium for a purchase may be information necessary to receive a printed book from an on-line bookseller. The physical artifact could be prepared in special form for the promotion, such as different cover art for a book, in order to increase the value of the premium, perhaps as a collector's item.

According to the present invention, four players are generally involved in the distribution and consumption of the content premium, although it may be noted that one party may actually play the role of multiple players. Those players are the customer, the retailer, the content provider, and an intermediary party. The intermediary party, which will be referred to herein as a content server, represents a business that provides advertising using the monetization model of the present invention. According to one or more aspects of the present invention, media content may be licensed by the content server in order to acquire an inventory of content premiums for packing and sell in content transfer contracts.

Utilization of the content premium through ipods, DVRs, or other players or storage devices may include, for example, the purchase of a product by a customer at a retail location. The general principle behind the present invention may be seen as advantageous for some of the same reasons as traditional promotions requiring a prior purchase, such as, for example, a child who purchases a particular brand of cereal because a desired toy is found inside the cereal box. The present invention, however, is directed to time-shifted media properties and optimized for the use of content storage players and appliances, thereby allowing maximum advertising monetization in this environment.

A premise behind the present invention is that the “brand” in today's marketplace is less defined by and derived from an advertising message and more defined by and derived from the primary entertainment or other media property content used to deliver the message. In other words, the topics, characters, lifestyles, interests, and other aspects which appeal to the consumer in the media itself form the image and message associated with the ownership and consumption of a product or service. Differences between products and services are today more likely to be recognized as illusory, transitory, or of little consequence; the appeal of an associated media property can sway the purchase and consumption of a product or service at the point-of-purchase more than an interstitial message delivered away from the point-of-purchase.

By utilizing the present invention, brand substitution for either knowledge or membership may be supplanted by access to community aggregate assessment and judgment of the value or a product or service. For example, consumers may have access to the aggregate consumer reviews regarding any product, solution, or service via the Internet or their cell phones. Consumers can thus choose the judgment of the broad market, or rely upon an assessment from within an affinity community with which such consumer perceives common traits.

Another result of the present invention is that it allows consumers to adopt the lifestyles, values, and potentially the corresponding purchase preferences via “influencers” or “thought leaders” within a community or social network. For example, instead of following the central tendency of the aggregate assessment, consumers generally desire to emulate success directly from recommendations or directions. This phenomenon is recognized in current marketing as the “early adopter” influence, but it is believed this trend will become more traceable and more broadly applied as technology products such as those described above become more prevalent in society and more sophisticated.

Applying the present invention, it may be seen how the invention overcomes the deficiencies described above with respect to the traditional means of purchasing interstitial advertising in media programs. First, patronage by a consumer can be negotiated via access to media properties. Using the present invention, a consumer may indicate a purchase preference, and the consumer's purchase subsequently influenced via a subscription list. For example, a manufacturer can previously have licensed media properties and can make selecting a subscription from these licenses available to influence a purchase decision at the point-of-purchase.

Another advantage of the present invention is that a consumer can indicate a subscription preference, and may influence the manufacturer's license acquisition. For example, a consumer may indicate a media property preference and a manufacturer can purchase a license to the media property via a “market” price for that license based upon demand, exclusivity, “leadership quotient” of the pending customer, or other factors. In essence, the present invention allows for a highly efficient market for the exchange of media licenses.

Another advantage of the present invention is that a consumer may be influenced based upon recommendations from any of a general community, an affinity group, or individuals. A consumer can glance at the “ratings” of either a product purchase or media subscription from groups to which he has membership, special interests, or geographic affinity, for example. A consumer can also receive “private” recommendations via family or friends to either a product or media property. This may be thought of as the manufacturer providing access to the aggregate judgments via a known intermediary “influencer.”

Another advantage of the present invention is that the purchase or consideration of purchase of a good or service is coupled explicitly with the delivery of a media property. A consumer must either purchase a product or service in order to receive a copy of a media property for consumption, or enter a retail location in order to receive a copy of a media property for consumption. The consumption of the good or service, however, is not necessarily “time-restricted” with respect to the consumer who made the required purchase or retail visit. That is, the consumer can retain the media for later consumption for as long as desired, so long as the consumer remains willing to dedicate storage capacity to retaining the media.

Another advantage of the present invention is that exchanging, trading, or passing copies of media to friends or associates is not restricted. It is, in fact, likely to be encouraged using various embodiments of the present invention. “Subscription markers” that associate the “original friend” with subsequent subscriptions may serve to create and identify “social networks” of like-minded people, as well as the “thought leaders” within a consumption community. Passing a copy of a media property to another user's portable storage device enables the present invention to identify the user as a member of the primary consumer's social network. The present invention also allows for the identification of the user as interested in the media property and therefore subject to purchase influence of one or more products within a product group through either purchase discounts or bundling.

Another advantage of the present invention is that the proliferation or acquisition of more media content than what can be consumed within any interval is of no consequence to the manufacturer or other advertiser, since the acquisition of the content has already altered the consumption behavior. In other words, the manufacturer cares that the media is consumed in as much only that demand is sustained for any media licenses. No interstitial messages are developed or associated with the media content. This means that these additional costs are avoided, that these messages cannot be ignored or by-passed, and that the efficacy of the messages to alter consumption behavior need be of no concern.

A related advantage of the present invention is that it eliminates the cost of advertising production for the sponsor. No interstitial advertising messages need to be produced in order to take advantage of the present invention. Furthermore, the present invention allows a direct coupling between the alteration of consumer behavior with the acquisition of media content, rather than the loose coupling using in traditional advertising methods to alter consumer behavior by means of advertisements inserted into content for which the consumer need not directly compensate the sponsor.

Finally, providing the primary option of delivery of media content at a retail or other location is preferred to downloading digital media directly over the Internet, since by distributing either known subscriptions or predicted “high probability” subscriptions into the retail or other location, the downloads can be copied to several points on a content server instead of pulled from few sources. This result lowers transmission costs and improves transmission performance.

These and other features, objects and advantages of the present invention will become better understood from a consideration of the following detailed description of the preferred embodiments and appended claims in conjunction with the drawings as described following:

### DRAWINGS

FIG. 1 is an illustration of the various main components of a preferred embodiment of the present invention.

FIG. 2 is a flow chart illustrating the steps in reaching an agreement between a content server and a content provider according to a preferred embodiment of the present invention.

FIG. 3 is a flow chart illustrating the steps in reaching an agreement between a content server and a retailer according to a preferred embodiment of the present invention.

FIG. 4 is a flow chart illustrating the steps in reaching an agreement between a content server and an Internet point of presence (POP) according to a preferred embodiment of the present invention.

FIG. 5 is a flow chart illustrating the steps by which a consumer receives a content premium according to a preferred embodiment of the present invention.

FIG. 6 is a flow chart illustrating a basic business process model according to a preferred embodiment of the present invention.

FIG. 7 is a hierarchical chart illustrating the components of the product acquisition workflow software module.

FIG. 8 is a hierarchical chart illustrating the components of the license management and billing software module.

FIG. 9 is a hierarchical chart illustrating the components of the server management software module.

FIG. 10 is a hierarchical chart illustrating the components of the POP management software module.

FIG. 11 is a hierarchical chart illustrating the components of the POP terminal application software module.

FIG. 12 is a hierarchical chart illustrating the components of the client terminal application software module.

FIG. 13 is a hierarchical chart illustrating the components of the content server subscription analysis software module.

### DETAILED DESCRIPTION OF THE PREFERRED EMBODIMENT(S)

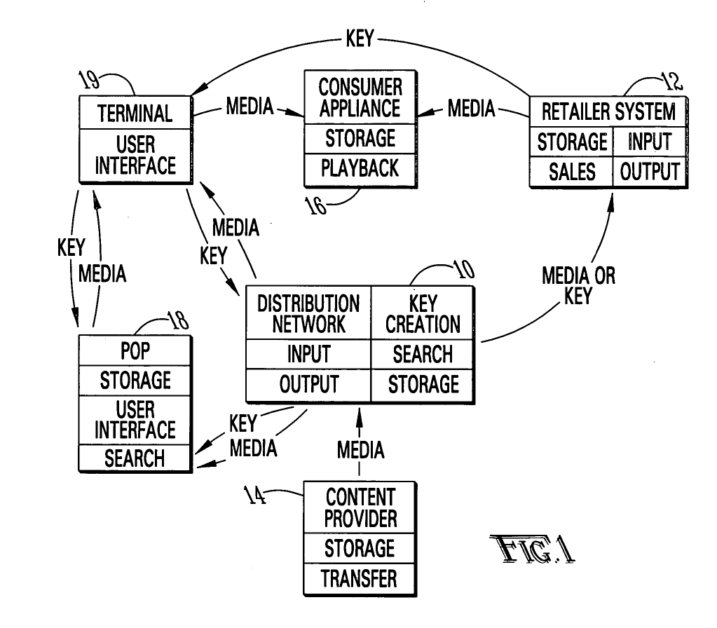

With reference to FIG. 1, a preferred embodiment of the present invention may now be described. Content server 10 comprises an input module, an output module, an input module, a search module, a key creation module, and a storage module. It may be seen that such modules (as well as the modules of other components of the preferred embodiment) may be implemented in computer software or hardware, as desired. In the preferred embodiment, an off-the-shelf, microprocessor-based server with storage capability may be used to implement content server 10. Retailer system 12 is preferably a computer system maintained by a retail establishment, and comprises a storage module, an input module, an output module, and a sales processing module. Content provider 14 is a computer system maintained by a party that generates media properties, and may be a single computer with a storage medium or a network. It also comprises a transfer module to send media content to content server 10. Consumer appliance 16 is preferably a device that can store and playback media properties, such as a DVR or iPod device. Point of presence (POP) 18 is a point on the Internet or another network that includes a storage module, user interface module, and a search module, the functioning of which will be described below in various preferred embodiments. POP 18 may be eliminated in certain embodiments. Terminal 19 may be used by a customer to communicate with POP 18 or content server 10 and includes a user interface; terminal 19 is preferably a personal computer or laptop computer, but the functions of terminal 19 may also be integrated in an alternative embodiment into consumer appliance 16.

In order to make use of the services offered by content server 10, a retailer operating retailer computer system 12 purchases the right through content server 10 for content server 10 to transfer a content premium to customer 16 through retailer system 12 when certain contract conditions are satisfied. The content premium is generated by a content provider system 14, which is then transmitted over a network such as the Internet to content server 10. Content server 10 may thus act as a clearinghouse for multiple content providers 14 and retailer systems 12 in the preferred embodiment, thereby maintaining a plurality of content premiums, each associated with a particular product or service, and perhaps uniquely associated with different products and services for different retailers.

The distributor acting through content server 10 may sell media transfer contracts to retailers acting through retailer systems 12, for example, in any variation or combination of a purchase being required; a purchase of an affiliate product being required; the provision of marketing data being required; and the acceptance of the media with embedded advertising being required. In turn, retailers may sell media transfer contracts to a customer associated with consumer appliance 16, for example, in any variation or combination of incentives for store or site patronage; incentives to purchase additional products; incentives to purchase a specific product or service (as, for example, an agent of the business); and incentives to provide lifestyle, interest, and customer-profile data.

As part of the media transfer contract, content server 10 may optionally provide any of a number of service or transaction support packages or bundles. One possible package is the “preference.” A preference is created where two or more content premiums are available as compensation, from which the customer associated with consumer appliance 16 may select the desired premium.

Another possible package is the “swap,” whereby the customer associated with consumer appliance 16 need not satisfy the primary terms to receive a content premium, but rather can substitute the purchase of one product to satisfy the transfer terms for another product. Reciprocal “swap” obligations are incurred by the second corporate product when the condition is satisfied. For example, a men's shaving blade company may own a content premium license, and also have a “swap” license agreement with a feminine hygiene products company. A male purchaser could thus receive the content premium via the purchase of a feminine hygiene product for his wife, or a female purchaser could acquire a content premium that she desired via the purchase of her husband's razor blades.

A “cross-sell” package allows the customer to satisfy the primary terms of a content premium transfer, but may be induced to additional purchases of the same or other products by the offer of discounted content premiums. This package may be popular with complementary items. For example, a customer may purchase a particular brand of beer in order to receive a sporting event premium. To induce the purchase of a snack food, such as pretzels, an additional content premium—such as, for example, an interview with players associated with the sporting event—could be offered as an additional enticement. In this example the content premiums are related, but they need not necessarily be connected. In addition, the content premiums need not be exercised together in order for the cross-sell package to be realized: for example, the customer could receive a Sunday afternoon sporting event premium for the purchase of beer, and receive a Monday night sporting event premium for the purchase of pretzels.

As a final example, the “up-sell” package allows the customer to be induced to purchase a competing product to receive a content premium. The distributor associated with content server 10 may develop, combine, sell, and deploy necessary technology to retailers associated with each retailer system 12 to support monitoring compliance with and fulfillment of media transfer contract terms and conditions; transfer and validated receipt of content premiums; and analysis of customer behaviors and subsequent refinement of business practices. This functionality is a part of the sales processing module at retailer system 12; the various software routines used to implement these functions will be described in greater detail below.

Various methods may be used to transfer the content premium to consumer appliance 16 either by means of or through terminal 19. These methods include WiFi, physical connection, or authentication code. WiFi, short for “wireless fidelity,” is the common term for high-frequency wireless local area networks (WLANs). Using WiFi transfer in the preferred embodiment, whenever consumer appliance 16 or terminal 19 moves within reception of a radio or laser network access point to POP 18, and the appropriate contract terms are satisfied, the user interface (comprising a utility program for this purpose) logs consumer appliance 16 or terminal 19 onto POP 18, transfers credentials and other data from the device to POP 18, and downloads the content premium to consumer appliance 16 or terminal 19. Using a physical connection, such as a computer docking station or the like, the device is physically connected to POP 18. As with the WiFi example, once the connection is established a utility determines if contract terms are satisfied, and if so logs consumer appliance 16 or terminal 19 onto POP 18, transfers credentials and other data from the device to POP 18, and downloads the content premium to the appropriate device. Using the authentication approach, POP 18 can issue an authentication code and Internet address, or uniform resource locator (URL) when contract terms are satisfied, and the consumer may then log in at the URL at a later time (through consumer appliance 16 or terminal 19) to download the content premium.

POP 18 according to a preferred embodiment may collect and maintain various types of data in its storage module. Such data includes the customer content premium preferences and subscriptions; customer purchases to satisfy premium terms; and content premium download status and transfer availability. The data may also include the applicable content premium terms themselves, including “swap”, “cross-sell”, and “up sell” terms.

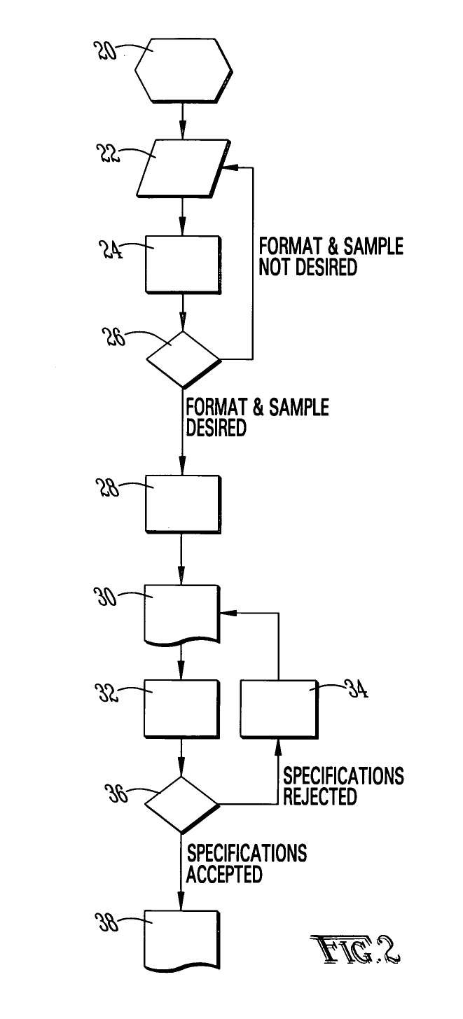

Referring now to FIGS. 2-4, the processes by which agreements may be established between the various parties involved in utilizing the preferred embodiment of the present invention may be described in more detail. FIG. 2 illustrates the process by which an agreement is arranged between distributor network 10 and a content provider 14 according to a preferred embodiment of the present invention. At action block 20, content provider 14 conceives of an original media property, produces an original version of a previous work, acquires coverage rights for an event, or otherwise acquires an interest in a media property. At input block 22, content provider 14 submits to content server 10 a proposed format and sample of the media property for review. At block 24, content server 10 evaluates the format and sample of the media property. Moving to decision block 26, content server 10 determines if the proposed media property from content provider 14 is desirable in light of its business plans for distribution as a content premium. If the media property is not approved, then processing returns to step 22. If it is approved, then processing moves to block 28, where content server 10 agrees to market the media property within its content premium allocation system.

At block 30, content server 10 provides to content provider 14 the delivery requirements and other technical specifications for the final media property to be delivered. At block 32, the necessary changes are made by content provider 14, and at block 34 content server 10 determines if the final media property specifications are acceptable. If not, then processing moves to block 34, where amendments are made and processing returns to block 30. If so, then processing moves to block 38, wherein final contractual arrangements are established between content server 10 and content provider 14.

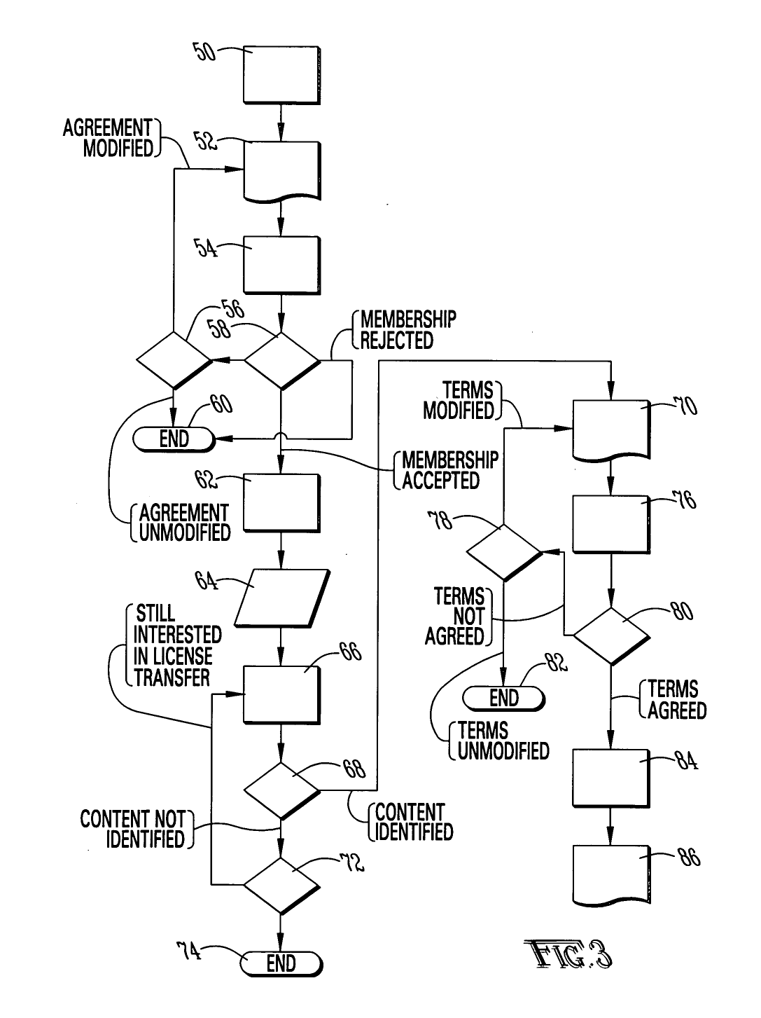

Referring now to FIG. 3, the process whereby an arrangement is formed between content server 10 and a retailer 12 may be described. While this arrangement is described here for a program with only one retailer 12, it may be seen that the same process may be applied regardless of the number of participating retailers 12. Likewise, the relationship may be formed with regard to a single content premium, or multiple content premiums, which may be provided with a single product or different products offered to the customers of retailer 12. At block 50, content server 10 establishes a contact or relationship with retailer 12, which is a potential licensee for content premiums. At block 52, content server 10 provides a proposed client agreement to retailer 12 for review. At block 54, retailer 12 considers the terms and conditions of membership within the system created by content server 10, and at decision block 58 determines whether it wishes to be a member. If retailer 12 does not wish to be a member under the stated terms and conditions, then processing moves to decision block 56, where content server 10 determines whether it wishes to make any proposed revisions to the agreement between the parties. If not, then the process terminates at step 60. If so, then processing returns to block 52.

If retailer 12 determines that it does wish to be a member of the network under the stated terms and conditions at decision block 25, then processing moves to block 62, where the agreement is executed. At block 64, content server 10 provides premium content samples to retailer 12 for its review. At block 66, retailer 12 determines which content premiums it wishes to associate with each of its products being considered for inclusion in this system, and at decision block 68 determines if it has identified a desired content premium or premiums for its products. If no desired content premium is identified, then processing moves processing moves to decision block 72, where retailer 12 determines if it wishes to consider other possible content premium proposals. If not, then the process ends at block 74. If so, then processing returns to block 66.

If retailer 12 determines that it has identified a desired content premium or premiums at block 68, then processing moves to block 70, where content server 10 establishes a price, duration, and other transfer forms associated with the particular content premium identified by retailer 12. Processing then proceeds to block 76, where retailer 12 considers these terms. If the terms are not accepted by retailer 12 at decision block 80, then processing moves to block 78 where content server 10 determines whether it is willing to modify these terms as requested by retailer 12. If so, then processing returns to block 70. If not, then the process ends at block 82.

If retailer 12 accepts the terms of content server 10 at block 80, then processing moves to block 84, where retailer 12 agrees to proposed terms. Processing then moves to block 86, where the parties agree to terms such that the transfer of the content premium or premiums may now take place.

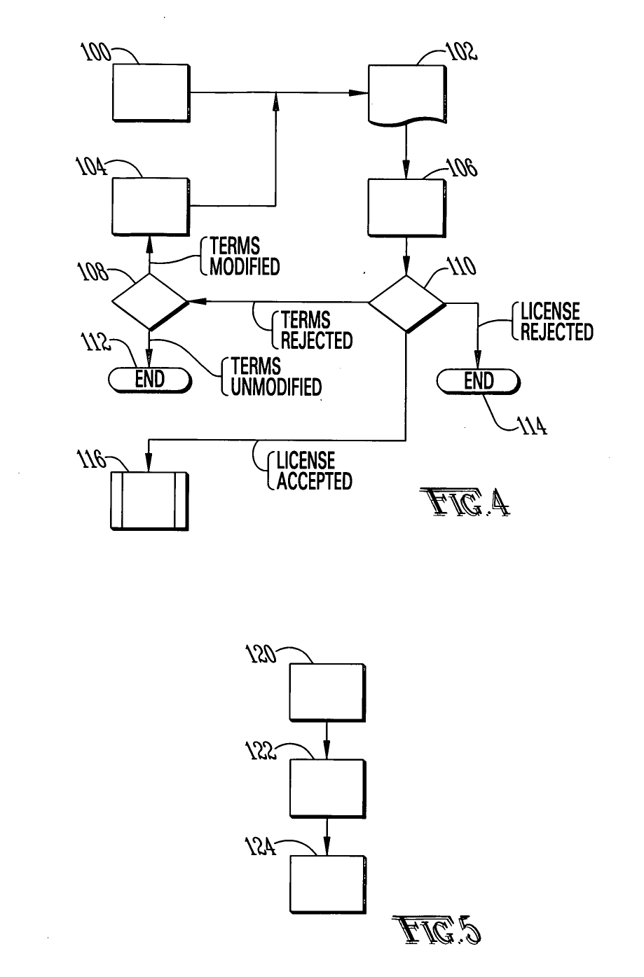

Referring now to FIG. 4, the process whereby an agreement may be established between the content server and an Internet point of presence (POP) may now be described. At block 100, content server 10 establishes a marketing contact or relationship with POP 18. At block 102, content server 10 provides POP 18 with a proposed agreement by which the content premium or related information may be transferred through POP 18. At block 106, POP 18 considers the proposed agreement, and at decision block 110 POP 18 determines whether it wishes to accept the proposed terms. If not, then processing moves to decision block 108, where content server 10 determines whether it wishes to propose alternate terms and conditions. If so, then the terms of the proposed agreement are modified at block 104, and processing returns to block 102. If not, then processing terminates at block 112.

If POP 18 determines that it wishes to accept the proposed terms of the agreement at block 110, then processing moves to block 116, where content server 110 provides, installs, and integrates all necessary hardware, software, network, and administrative services at POP 18's retail locations in accordance with the terms of the agreement. If at block 110 POP 18 determines that it does not wish to enter the proposed agreement even under any alternate terms and conditions, then processing terminates at block 114.

Referring now to FIG. 5, the process whereby the consumer 16 receives a content premium according to a preferred embodiment of the present invention is described. At block 120, consumer 16 acquires a device capable of loading or storing the content premium. Such device may be acquired, for example, by means of purchase, rent, or lease. Such device may or may not be provided by one of retailer 12 or content server 10. At block 122, At block 124, consumer 16 provides transfer access to content server 10 or a designated agent of content server 10 for the transfer of a content premium or premiums to the storage device acquired by consumer 16. At block 124, consumer 16 acquires access to a device with playback capability for playing the content premium stored on the storage device of consumer 16. The playback device and storage device of consumer 16 may in fact be the same device, or may be different devices. The playback device may be a hardware device, a software application, or a combination of both.

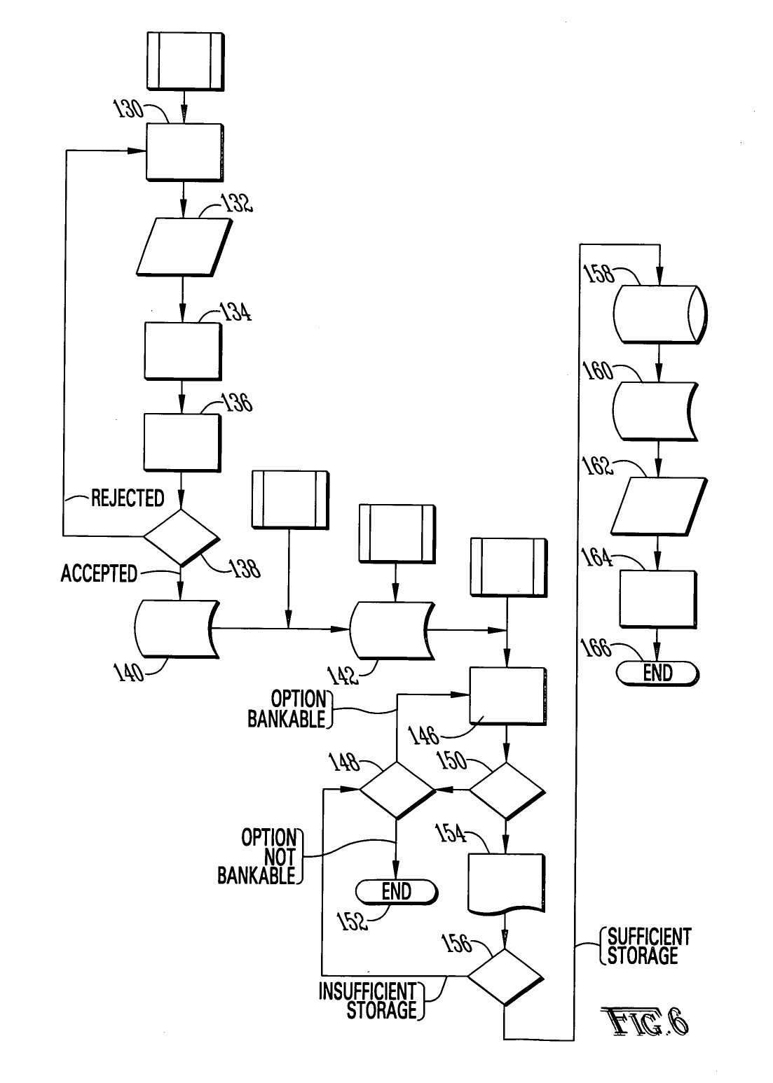

Referring now to FIG. 6, a basic business model may be described for use of the preferred embodiment of the present invention. At block 130, content provider 14 produces a media property suitable for capture or development and digital transfer. It may be seen that this step follows in sequence from the steps outlined in reference to FIG. 2 above. At block 132, the content premium developed by content provider 14 is packaged as a digital file in accordance with production specifications. For an audio file, for example, those specifications may be MP3 format. At block 134, the content premium is transferred from content provider 14 to content server 10. At block 136, the content premium is checked by content server 10 to validate compliance with the applicable license agreement. Content server 10 may maintain a quality. assurance department for this purpose. At decision block 138, content server 10 determines whether the content premium is acceptable or should be rejected. If rejected, processing returns to block 130. If accepted, then processing moves to block 140, where the content premium is stored digitally in a library file maintained on a storage system by content server 10.

Following the various steps outlined in reference to FIGS. 3 and 4 above, processing moves to step 142, where the content premium is transferred to the local storage system of retailer 12 or POP 18 for later distribution to consumer 16. At step 146, consumer 16 purchases a product or service from retailer 12, and the purchase is validated in some manner by retailer 12 as appropriate to the product or service purchased. At decision block 150, retailer 12 inquires of consumer 16 whether consumer 16 desires the content premium associated with the product or service purchased to be transferred immediately to the consumer 16's storage device. It may be noted here that consumer 16 at this point should have already acquired the storage device as detailed above in reference to FIG. 5. If consumer 16 does not desire an immediate transfer, then at decision block 148 retailer 12 determines whether, under the applicable program and with respect to the content premium and product or service at issue, the content premium is “bankable,” that is, may be transferred to consumer 16 at a later time. If so, then processing returns to block 146. If not, then the content premium is not transferred to consumer 16, and processing ends at block 152.

If consumer 16 indicates at block 150 that it desires an immediate transfer, then processing proceeds to block 154, where retailer 12 checks the storage capacity of consumer 16's storage device. This may be performed automatically by software that is integrated into the transfer process. At decision block 156 it is determined whether the storage device has sufficient free storage capacity to allow the transfer of the content premium to take place. If storage is insufficient, then processing moves to decision block 148, where it will be determined if the content premium is bankable. If storage is sufficient, then processing moves to block 158, where the content premium is in fact transferred to the storage device of consumer 16. At block 160, consumer 16 maintains the content premium in storage until such time as it is desired to play the content premium, preferably utilizing software associated with the storage advice. At block 162, consumer 16 retrieves the content premium on the storage device for purposes of playback. Again, this process is preferably performed by software incorporated into the storage device. At block 164, the consumer plays the content premium using the playback device (as acquired in the steps described above with reference to FIG. 6), and processing ends at block 166. Consumer 16 may maintain the content premium in the storage device as long as desired for replay purposes, or may delete the content premium in order to make room for additional content on the storage device.

The present invention encompasses a number of alterative embodiments to that described above with respect to FIGS. 2-6. For example, instead of each retailer 12 maintaining the actual coupon premiums themselves at a local storage device, retailers 12 may maintain digital keys that may be used to later unlock the coupon premium by consumer 16, as shown in FIG. 1. Once the keys are transferred to the storage device of consumer 16, they may be sent to content server 10, by digital network such as the Internet or other means, in order to retrieve the content premium. Likewise, POP 18 may be used to retrieve content premiums by consumer 16, also as shown in FIG. 1.

An example may be used to illustrate the embodiments described above. Suppose that consumer 16 regularly purchases brand “A” toothpaste. Consumer 16 may not believe, however, that the difference between brand “A” toothpaste and brand “B” is so great that he or she will not switch to brand “B” if a purchase of that brand will enable consumer 16 to watch a new video being released by a favorite recording artist. If the manufacturer of brand “B” were, through the applicable retailer, to offer this video as a content premium, consumer 16 may then purchase brand “B.” The content may then be downloaded directly to a portable storage and playing device at the retailer, or consumer 16 may receive a digital key to unlock the content at a remote site, or consumer 16 may receive a URL and password in order to access the content premium at a remote site. The consumer having begun using brand “B” may now continue using brand “B” out of habit, regardless of whether the content premium, or a like content premium, is again provided.

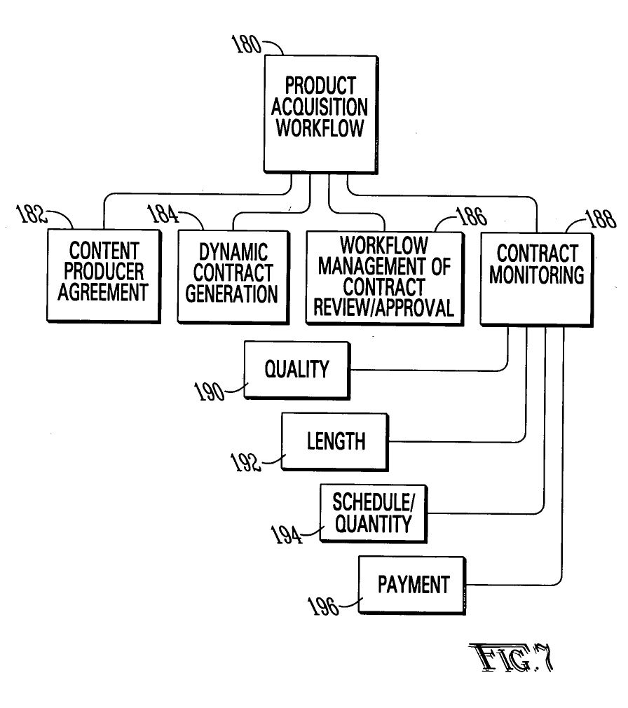

The preferred embodiment of the present invention has thus far been described in terms of the functionality of various hardware and network components. The modular structure of the software components that provide this functionality for the preferred embodiment of the present invention may now be described with reference to FIGS. 7-13. Turning first to FIG. 7, the structure of the application software module for product acquisition workflow 180 may first be described. The general function of this software module, which preferably resides at content server 10, is to automate the process of securing contracts between content server 10 and content providers 14 for the distribution of content premiums. Content producer agreement subroutine 182 is operable to generate a standard contract for the distribution of content with terms acceptable to content server 14. Dynamic contract generation subroutine 184 is responsible for generating content provider-specific terms for the contract generated by content producer agreement subroutine 182, such as the name of the content provider, the name of the content premium, and various specific information regarding each, resulting in a completed first draft of the contract in an electronic form. Workflow management of contract review/approval subroutine 186 automates the process of reviewing and approving changes that may take place during the negotiation process. Contract review/approval subroutine 186 preferably includes the functionality of highlighting changes that have occurred during each stage of the negotiation, and may preferably contain rules for setting allowable ranges in the changing of various contract terms. Contract monitoring subroutine 188 provides for automation of the ongoing maintenance of an executed contract. Its various components include quality component 190, which allows for automation of the quality of content premium provided; length component 192, which provides monitoring for the length of the contract and appropriate actions upon expiration or, for renewal purposes, when approaching expiration; component 194, which provides for monitoring of the delivery schedule and quantity of content premiums under the contract, and component 196, which provides monitoring of the performance of payment terms by the content server agent under the contract.

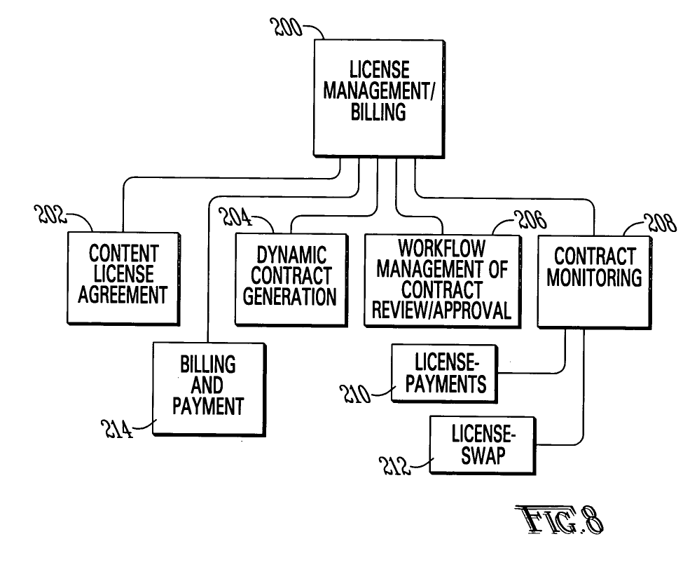

Referring now to FIG. 8, the structure of license management and billing module 200 may be described. The general function of this module, which preferably resides at content server 10, is to automate the management of contracts for the provision of content premiums by content server 10 to retailers 12. Content license agreement subroutine 202 is operable to generate a standard contract for the distribution of content with terms acceptable by content server 10, and further in keeping with the contract executed between content server 10 and the applicable content provider 14 with respect to the content premium at issue. Dynamic contract generation subroutine 204 is responsible for generating retailer-specific terms for the contract generated by content license agreement subroutine 202, such as the name of the specific retailer 12 at issue, the name of the content premium, and various specific information regarding each, resulting in a completed first draft of the contract in an electronic form. Workflow management of contract review/approval subroutine 206 automates the process of reviewing and approving changes that may take place during the negotiation process. Contract review/approval subroutine 206 preferably includes the functionality of highlighting changes that have occurred during each stage of the negotiation, and may preferably contain rules for setting allowable ranges in the changing of various contract terms. Contract monitoring subroutine 208 provides for automation of the ongoing maintenance of an executed contract. Its various components include license—payments component 210, which allows for automation of the monitoring of licenses that involve monetary payment from retailer 12, and license—swap component 212, which allows for automation of the monitoring of licenses that are granted on the basis of a swap for rights to other content. Billing and payment subroutine 214 provides monitoring of the performance of billing and payment terms under the applicable contract.

Referring now to FIG. 9, the structure of server management module 220 may be described. The general function of this module, which preferable resides at content server 10, is to administer the transfer of retrieval of content premiums and various data through content server 10. The two main subroutines are premium transfer subroutine 222 and data retrieval subroutine 224. The general function of premium transfer subroutine 22 is to transfer content premiums and related information to retailers 12, consumer terminals 19, and POP servers 18. The general purpose of data retrieval subroutine 224 is to retrieve information from other system components concerning data related to the content premium licensing program.

Premium transfer subroutine 222 may be split into two components, content transfer 226 and data transfer 228. The general purpose of content transfer component 226 is to transfer content premiums to various licensees and to provide information related to their transfer, as applicable. Its sub-components include known subscriptions loader 230, which provides content premiums for known subscription requests; probable subscription loader 232, which provides content premiums for probable subscription requests; and on-demand subscription loader 234, which provides content premiums for parties that provide content premium on an on-demand basis to the end consumers. Probable subscriptions are subscriptions for which a consumer has a high probability of subscribing to based on, for example, the customer's current subscriptions, his or her known cultural or premium affinity groups or associated “thought leaders,” and his or her geographic location or retail venue profiles. Another sub-component of content transfer component 226 is key and remote subscription authentication sub-component 236, which is responsible for receiving keys transmitted by, for example, a consumer terminal 19, and authenticating the key received for purposes of transferring a content premium based upon the verification of a valid subscription. The other component of premium transfer subroutine 222, data transfer 228, includes transfer license data sub-component 238; this sub-component provides the capability of transferring key data from the applicable license agreement to other parties in the network for purposes of verification that such terms are being met by the various actions of the applicable parties.

Data retrieval subroutine 224 may be split into various components according to the type of information being retrieved from other remote elements of the system. Subscription list retrieval component 240 provides for the retrieval of the list of current subscribers in the system; negotiated promotions retrieval component 242 provides for the retrieval of the current promotions that are the subject of executed contracts with other remote elements on the system; and forwarded premium retrieval component 244 provides historical data concerning premiums that have been licensed and transferred using the system.

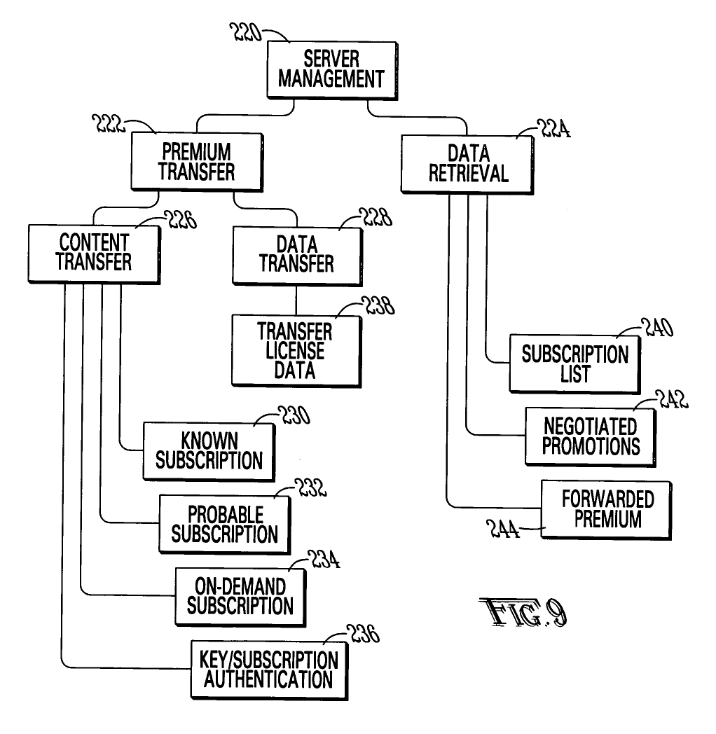

Referring now to FIG. 10, the structure of POP management module 240 may be described. The general function of POP management module 240, which preferably resides at content server 10, is to provide automation for the management of the various subscription agreements maintained through the system network. It is comprised of a number of subroutines for this purpose. Display and appeal subroutine 244 provides functionality for a consumer to know what content premiums are available and associated with which purchase terms. It manages the presentation of available content premiums associated with a particular purchase. “Display and appeal” may be as simple as a program list, or it may manage in-store shelf displays; in the preferred embodiment, however, it is operable to make a wireless connection, real-time audio appeal via a consumer's telephone or portable content player.

Subscriber demographic management subroutine 246 maintains demographic information for subscribers, which may be used for purposes such as marketing and data mining. Subscription management subroutine 248 allows a consumer to indicate his or her subscription preferences where more than one premium is available through a purchase via licensing or swap arrangements, or a content premium is desired but the consumer does not have access to it through his or her current purchases. This latter situation indicates a situation where the premium is found to be insufficient to sway a purchase.

Retailer and co-licensee negotiation subroutine 250 utilizes the demand data acquired from subscription management subroutine 248 to enable retailers and co-licensee's to propose “swap” or bundling contracts to their mutual advantage. The purpose of the module is to facilitate these proposals and the definition of their terms. Likewise, licensee and peer licensee swap accounting subroutine 252 establishes and tracks any swap or bundling proposals that are entered into by agreement between parties during negotiations facilitated by either the automation within retailer and co-licensee negotiation subroutine 250 or directly by the intervention of an agent. Specific accounting issues may limit the number of swaps available to a side, to prevent, for example, a situation where one licensee ends up providing all of the content premiums while the other provides none, or the module may simply monitor the term of the agreement.

Licensee and content server real-time market auctions subroutine 254 provides the functionality for a licensee to either increase or decrease the favorability of its terms via auction; that is, it can establish a swap contract with a potential co-licensee on the basis of a competitive auction for either money, other content premium licenses, or other consideration. Customer account sharing with approved POPs module 256 enables both retailers and customers to “share” subscriptions. For example, a customer may leave a grocery store and travel to another store that has a subscription sharing agreement. Once in the second store, the customer would not be required to necessarily create a subscription unique to that store. This enables stores to affiliate their subscription servicing—or to remain exclusive, as desired.

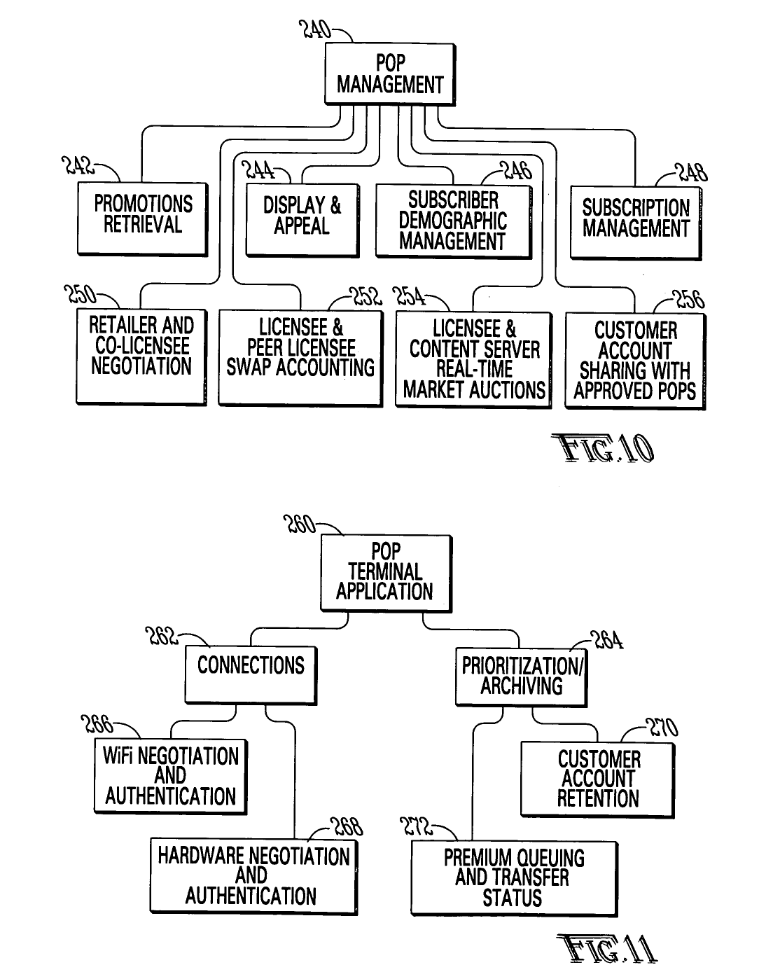

Referring now to FIG. 11, the structure of POP terminal application module 260 may be described. The general function of POP terminal application module 260, which preferably resides at POP server 18, is to provide functionality to POP server 18 in order to facilitate its functionality within the overall system network. Pop terminal application module 260 is comprised of connections subroutine 262 and prioritization/archiving subroutine 264. The general function of connections subroutine 262 is to negotiate network connections made for the purpose of the transfer of content premiums, and to authenticate the identity of parties seeking to receive a content transfer. The general function of prioritization/archiving subroutine 264 is to manage customer accounts and the transfer of content premiums once a connection is established.

Connections subroutine 262 is comprised of WiFi negotiation and authentication component 266 and hardware negotiation and authentication component 268. The function of WiFi negotiation and authentication component 266 is to negotiate a connection for the purpose of transferring a content premium by means of a wireless (WiFi) connection, and authenticate that the person seeking the transfer is in fact authorized to receive the transfer. The function of hardware negotiation and authentication component 268 is to negotiate a connection for the purpose of transferring a content premium by means of a wired network connection, and authenticate that the person seeking the transfer is in fact authorized to receive the transfer.

Prioritization/archiving subroutine 264 is comprised of customer account retention component 270 and premium queuing and transfer status component 272. Customer account retention component 270 enables the customer to allocate storage quotas rules for premiums, based on such factors as consumption status, age, and relative priority. Customer account retention component 270 also enables the customer to make manual determinations concerning the retention of a particular premium, such as delete, delete if space is needed for new content, never delete, prompt for deletion, or delete if within retrieval window end data by a certain number of days. The function of premium queuing and transfer status component 272 is to manage the physical aspects of a transfer of a content premium, including managing a queue of transfers when multiple transfers are pending.

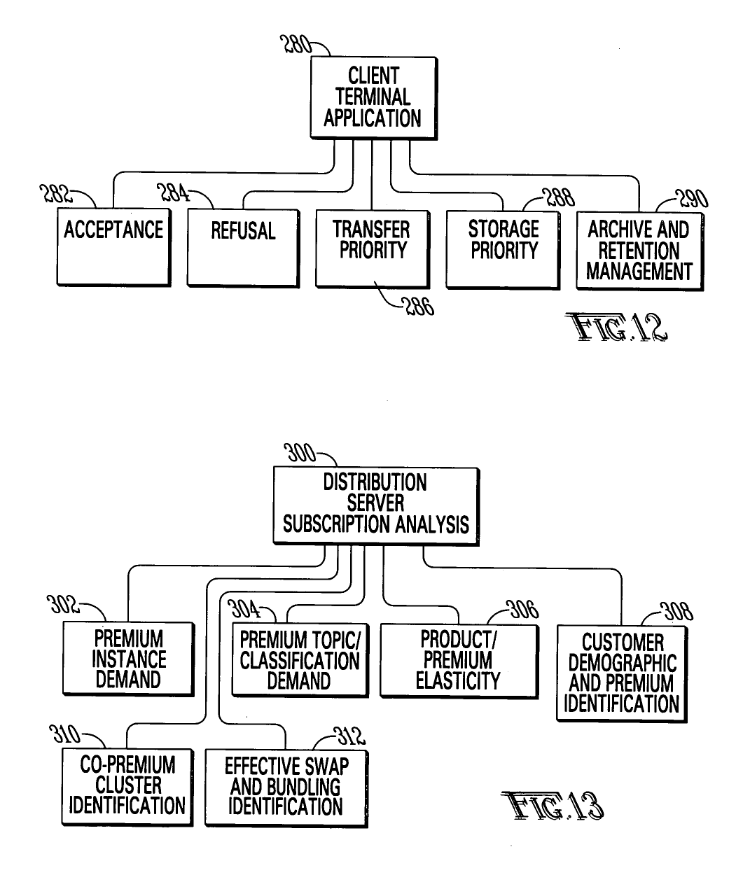

Referring now to FIG. 12, the structure of client terminal application module 280 may be described. The general function of client terminal application module 280, which preferably resides at each retailer 12, is to provide the functionality to retailer 12 in order to facilitate its functionality within the overall system network. Client terminal application module 280 is comprised of acceptance subroutine 282, refusal subroutine 284, transfer priority subroutine 286, storage priority subroutine 288, and archive and retention management subroutine 290. Acceptance subroutine 282 functions to perform processing related to the acceptance of a subscription at retailer 12 from content server 10. Refusal subroutine 284 functions to perform processing related to the refusal of a subscription at retailer 12 from content server 10. Transfer priority subroutine 286 functions to handle priority issues related to the transfer of content premiums to retailer 12, while Storage priority subroutine 288 functions to handle storage priority issues related to the transfer of content premiums. Archive and retention management subroutine 290 functions perform various recordkeeping tasks associated with subscription processing, including the retention of copies of all current and past subscriptions and the content premiums that have been transferred through retailer 12.

Referring now to FIG. 13, the structure of content server subscription analysis module 300 may be described. The general function of server subscription analysis module 300, which preferably resides at content server 10, is to provide the functionality to content server 10 in order to perform certain non-real time analysis of the results of the content premium program. Server subscription analysis module 300 is comprised of premium instance demand subroutine 302, premium topic/classification demand subroutine 304, product/premium elasticity subroutine 306, customer demographic and premium identification subroutine 308, co-premium cluster identification subroutine 310, and effective swap and bundling identification subroutine 312.

Premium instance demand subroutine 302 functions to keep track of the number of requests and downloads for each of the content premiums offered through content server 10. This information is used by other subroutines within content server subscription analysis module 300. Premium topic/classification demand subroutine 304 functions to determine and track the demand for content premiums based upon the topic area or classification of the premium. For example, this might include the classifications “music” and “spoken word,” and might also include various sub-classifications within broader classifications, such as “news” and “audio books” within the “spoken word” classification.

Product/premium elasticity subroutine 306 functions to calculate and track the elasticity of demand for the product with respect to the premium promotion. Elasticity is an economic concept that generally indicates the degree to which the demand for a product varies with respect to price or other factors, in this case the key factor being the presence of a content premium. Customer demographic and premium identification subroutine 308 is used to correlate information concerning desirable product premiums with demographic information for the customers who received such a content premium. The demographic information may be obtained from a retailer 12, from the customer directly, or through third-party data services. The results obtained from customer demographic and premium identification subroutine 308 may be used to calculate the best content premium for a particular future product.

It is anticipated that many premiums will have natural co-premiums, that is, complementary premiums with a highly predictive correlation. Co-premium cluster identification subroutine 310 functions to examine consumer premium seeking behavior, especially for those premiums pursued via swap or bundling strategies, in an attempt to identify opportunities for swap and bundling strategies and to facilitate correct and effective pricing for those agreements. Effective swap and bundling identification subroutine 312 uses data from co-premium cluster identification routine 310 to posit initial contract terms suitable for matchmaking propositions for retailer and co-licensee negotiation module 250.

The present invention has been described with reference to certain preferred and alternative embodiments that are intended to be exemplary only and not limiting to the full scope of the present invention as set forth in the appended claims.

I claim:

1. A method of monetizing time-shifted media properties, comprising the steps of:
(a) storing a digital media property on a content provider digital media storage medium associated with a content provider;
(b) transmitting said media property from said content provider storage medium to a content server digital storage medium associated with a content server;
(c) transmitting one of said digital media property and a matching digital media property key from said content server storage medium to a retailer digital storage medium associated with a retailer;
(d) recording the purchase by a consumer of a product associated with said media property;
(e) transferring said one of said digital media property and said digital media property key to a consumer digital storage device in response to said request.

2. The method of claim 1, further comprising the steps of:
(a) transmitting said digital media property key from said consumer storage device to said content server;
(b) searching for said digital media property that matches said digital media property key on said content server storage medium; and
(c) transmitting said digital media property from said content server to said consumer.

3. The method of claim 1, further comprising the steps of:
(a) transmitting said digital media property key from said consumer storage device to a point of presence (POP);
(b) searching for said digital media property that matches said digital media property key on a POP digital storage medium; and
(c) transmitting said digital media property from said POP to said consumer.

4. A method of monetizing media properties, comprising the steps of:
(a) providing at least one content provider each comprising a storage medium, said storage medium comprising a plurality of media properties;
(b) providing a content server comprising a storage medium, a search module, a media property receiving module, and a media property output module;
(c) receiving at said media property receiving module a plurality of content premiums from said at least one content provider, and storing said premiums at said content server storage medium;
(d) providing a plurality of retailers, each retailer comprising a retailer storage medium, a media property intake module, and a sale processing module;
(e) receiving at said retailer intake modules one of a premium and a matching premium key from said content server output module;
(f) providing a consumer storage module and a consumer playback module;
(g) receiving an indication of a sale at the retailer sale processing module, and in response transferring one of the premiums or matching keys to the consumer storage module;
(h) playing a premium at the consumer playback module.

5. The method of claim 4, further comprising the steps of:
(a) transmitting a key from the consumer storage module to the content server receiving module;
(b) at the content server search module, searching for the premium that matches the key received at the content server receiving module; and
(c) transmitting the premium from the content server output module to the consumer storage module.

6. The method of claim 4, further comprising the steps of:
(a) providing a point of presence (POP) comprising a POP storage medium, a POP input module, a POP output module, and a POP searching module.
(b) transmitting a key from the consumer storage module to the POP input module;
(c) at the POP search module, searching for the premium that matches the key at the POP storage module; and
(d) transmitting the premium from the POP output module to the consumer storage module.

7. An apparatus for the monetization of time-shifted media properties, comprising:
(a) a content provider digital storage medium;
(b) a content server in communication with said content provider storage medium, said content server comprising a content server digital storage medium;
(c) means for transferring said digital media property from said content provider to said content server;
(d) a retailer digital storage medium;
(e) means for transferring said digital media property from said content server to said retailer;
(f) a consumer digital storage device;
(g) means for transferring said digital media property from said retailer storage medium to said consumer storage device; and
(h) a digital media property, wherein said digital media property is operable to be stored on said content provider storage medium, said content server storage medium, said retailer storage medium, and said consumer storage device, and wherein said digital media property is operable to be transferred between said content provider storage medium and said content server storage medium; said content server storage medium and said retailer storage medium; and said retailer storage medium and said consumer storage device.

8. An apparatus for the monetizing of media properties, comprising:
(a) a content provider comprising a storage module and a transfer module;
(b) a content server in communication with said content provider comprising a storage module, a media input module, a media output module, and a search module;
(c) a retailer in communication with said content server comprising a storage module, a media input module, and a sales processing module; and
(d) a consumer media appliance comprising a storage module and a playback module, wherein said consumer media appliance storage module is operable to communicate with said retailer media output module.

9. The apparatus of claim 8, wherein said content provider transfer module is operable to transfer a media property from said content provider storage module to said content server media input module, and said content server media input module is operable to store said media property at said content server storage module.

10. The apparatus of claim 9, wherein said content server output module is operable to transfer said media property from said content server storage module to said retailer input module, and said retailer input module is operable to store said media property at said retailer storage module.

11. The apparatus of claim 10, wherein said retailer sales processing module is operable to send said media property from said retailer storage module to said consumer storage module in response to a sale for a product corresponding to said media property.

12. The apparatus of claim 8, wherein said content server further comprises a key generation module operable to create a key corresponding to a media property.

13. The apparatus of claim 12, wherein said content server output module is operable to transfer said key from said content server storage module to said retailer input module, and said retailer input module is operable to store said key at said retailer storage module.

14. The apparatus of claim 13, wherein said retailer sales processing module is operable to send said key from said retailer storage module to said consumer storage module in response to a sale for a product corresponding to said media property.

15. The apparatus of claim 14, wherein said content server input module is operable to receive said key from said consumer media appliance, said content server search module is operable to identify said media property matching said key, and said content server output module is operable to transmit said media property from said content server storage medium to said consumer media appliance.

16. The apparatus of claim 13, wherein said retailer sales processing module is operable to print said key from said retailer storage module onto a human-readable medium.

17. The apparatus of claim 14, further comprising a point of presence (POP) in communication with said content server and said consumer media appliance, said POP comprising a storage module, a key input module, a media output module, and a search module.

18. The apparatus of claim 17, wherein said POP key input module is operable to receive said key from said consumer media appliance, said POP search module is operable to identify said media property matching said key, and said POP output module is operable to transmit said media property from said POP storage module to said consumer media appliance.

19. The apparatus of claim 16, further comprising:
(a) a point of presence (POP) in communication with said content server, said POP comprising a storage module, a user interface module, and a search module; and
(b) a consumer terminal in communication with said POP and said consumer media appliance, said terminal comprising a user interface.

20. The apparatus of claim 19, wherein said POP user interface module is operable to receive a key from said terminal user interface, said POP search module is operable to identify said media property matching said key, and said POP user interface is further operable to output said media property from said POP storage module to said terminal.

21. The apparatus of claim 20, further comprising the step of transferring said media property from said terminal to said consumer media appliance.
